(19) United States
(12) Patent Application Publication
(10) Pub. No.: US 2015/0098684 A1
(43) Pub. Date: Apr. 9, 2015

(54) MODULAR BREAK OUT FOR CABLE ASSEMBLY

(71) Applicant: Tyco Electronics Corporation, Berwyn, PA (US)

(72) Inventors: Robert Neil Mulfinger, York Haven, PA (US); Matthew Lynn Burkholder, Lititz, PA (US)

(21) Appl. No.: 14/506,985

(22) Filed: Oct. 6, 2014

Related U.S. Application Data
(60) Provisional application No. 61/887,685, filed on Oct. 7, 2013.

(51) Int. Cl. G02B 6/44

(52) U.S. Cl. CPC G02B 6/4459; G02B 6/4473; G02B 6/4476
USPC 385/135

(57) ABSTRACT

A conduit distribution component comprising: (a) a body having at least a first and second end and a first and second side; (b) a first conduit opening at the first end; (c) a plurality of second conduit openings at the second end; and (d) at least one connector on at least the first side or the second side of the body for connecting the conduit distribution component to a second body of a second conduit distribution component in a side-by-side arrangement.

### FIELD OF THE INVENTION

The present invention relates to the field of communication technologies, and in particular, to a prefabricated optical conduit cable distribution assembly for separating and conveying individual conduits from a multiple optical conduit cable in a protective manner.

### BACKGROUND OF THE INVENTION

Optical conduits are increasingly used in a variety of communications applications, including voice, video, and data transmissions. To effectively use optical conduits in a transmission system, it is often desirable to access and terminate pre-selected optical conduits at predetermined locations along the length of a conduit optic cable, thus providing one or more access locations for distributing the optical conduits.

Use of multi-conduit distribution cables in a conduit optic communications network can present certain challenges. For example, optical conduits in multi-conduit distribution cables can be damaged if the cable is subject to excessive bending. To prevent or reduce excessive bending, conventional prior art solutions involve disposing a sleeve of heat shrink material around individual conduits to restrict bending. Although the conventional belief is that the heat shrink sleeve provides strain relief, Applicants believe that such an assembly is not structurally sound and does not prevent damage to the conduits. Furthermore, installation of heat shrink sleeves requires heating the sleeve, which is subject to inconsistencies. For example, variations in heating the sleeve can cause pinch points at the breakout. Additionally, in many instances, the heat shrink includes adhesive that flows into the assemblies or devices resulting in undesirable consequences such as fixation of conduits to the heat shrink, protective tubing and other parts of the assemblies. These inconsistencies and the different materials used in the cable assembly tend to affect disparately the attenuation of signals in the conduits as the cable is moved or subjected to temperature changes due to the different co-efficient of expansion for the different materials.

Consequently, there is a need for conduit optic cable distribution designs that facilitate the easy access of optical conduits, allow conduits to remain free or independent of the breakout, and protect the conduits from damage.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides a module optical conduit distribution component that is configured to facilitate not only conduit breakouts, but also the interconnection of the components, side-by-side, to create assemblies of any desired size. Accordingly, one aspect of the invention is a distribution component having a plurality of breakout points and at least one connector to enable the components to be connected to each other in a side-by-side configuration. In one embodiment, the conduit distribution component comprises: (a) a body having at least a first and second end and a first and second side; (b) a first conduit opening at said first end; (c) a plurality of second conduit openings at said second end; and (d) at least one connector on at least said first side or said second side of said body for connecting said conduit distribution component to a second body of a second conduit distribution component in a side-by-side arrangement.

Another aspect of the invention is an assembly of conduit distribution components in a side-by-side arrangement.

### BRIEF DESCRIPTION OF DRAWINGS

FIGS. 1(A) and 1(B) are perspective views of an optical conduit distribution component in accordance with an embodiment of the present invention.

FIG. 2 illustrates a perspective view of an assembly of multiple optical conduit distribution components stacked together.

FIG. 3 illustrates an end view of an assembly of multiple optical conduit distribution components stacked together.

FIG. 4 illustrates a locking nut inserted into a counterbore of an optical conduit distribution component in accordance with an embodiment of the present invention.

FIG. 5 illustrates an exemplary embodiment in accordance with the present invention in which conduits are distributed through stacked optical conduit components.

FIG. 6 illustrates heat sleeves placed over each tubing-first conduit opening and tubing-second conduit opening transitions of multiple optical conduit distribution components in accordance with an embodiment of the present invention.

### DETAILED DESCRIPTION

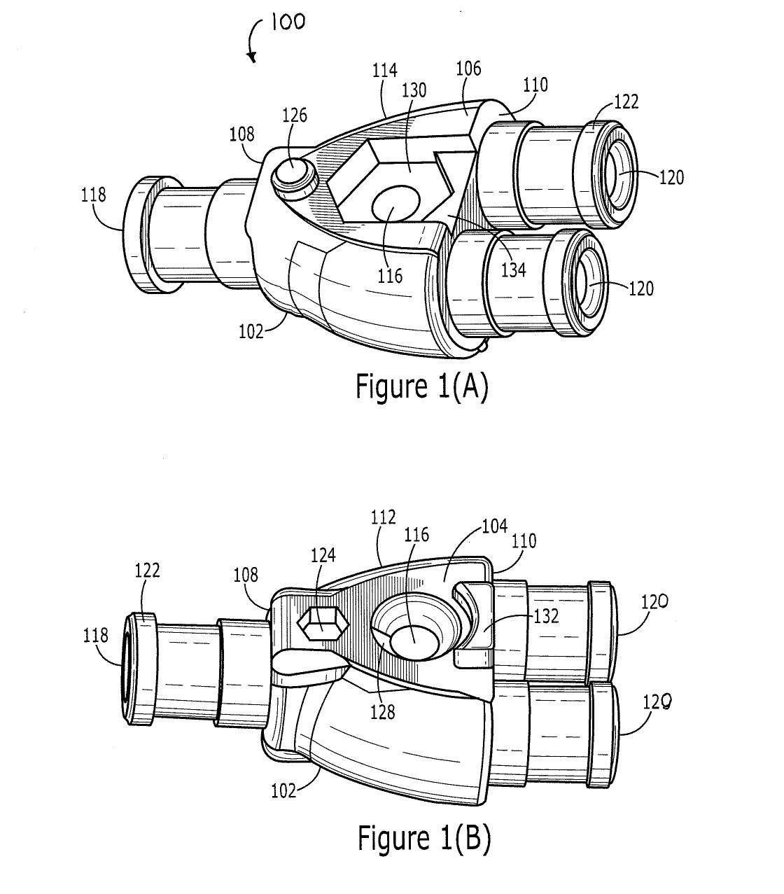

Referring now to the drawings, and more particularly, to FIGS. 1(A) and 1(B), one embodiment of a conduit distribution component 100 is shown. It should be understood that conduit refers to any known medium for conducting signals and includes, for example, electrical conduit, such as copper or aluminum, and optical conduit such as glass and plastic fibers and waveguides.

The optical conduit distribution component 100 includes a Y-shaped body 102 having a first side 104, second side 106, first end 108, second end 110, and walls 112 and 114. Edges formed by first side 104 and second side 106 merge with walls 112 and 114 are smooth or curved such that walls 112 and 114 form a curved surface. The ends, sides and walls 104-114 together form component body 102, which, in one embodiment, has a rectangular cross-section with semi-circular sides.

Component body 102 includes a first conduit opening 118 located at the first end 108 and second conduit openings 120 located at the second end 110. In some embodiments in accordance with the present invention, first conduit opening 118 and second conduit openings 120 are tubular-shaped capable of receiving multiple conduits/conduit cables bundled together using conventional technique. In such embodiment, diameter of first conduit opening 118 and second conduit openings 120 can be adjusted to accommodate conduit bundles including larger diameter conduit cables. In one embodiment of the present invention, component body 102 includes two second conduit openings 120 capable of splitting at least two conduits in a conduit bundle received through first conduit opening 118. It should be understood, however, that the component body may be configured with three or more second openings. Edges along the outer circumference of first conduit opening 118 and second conduit openings 120 are raised to form lips 122 capable of receiving and securing heat shrink sleeves. In one embodiment of the present invention, lips 122 are capable of receiving and securing an injection molded boot and/or strain relief in substitution of the heat shrink sleeve.

An important feature of the conduit distribution component 100 is the connector on at least the first side or the second side of the body for connecting the conduit distribution component to a second body of a second conduit distribution component in a side-by-side arrangement. The connector can be any body configuration, device or combination of body configurations and/or devices that facilitate the connection of component bodies in a side-by-side relationship. Examples of suitable connectors include interconnecting body portions (e.g. posts and receptacles), latches, clips, fasteners (e.g., bolts, hook and loop strips), adhesives (e.g. double sided tape), and magnets, and any combination of two or more of these.

Referring to FIGS. 1(A) and 1(B), one embodiment of the connector is shown comprising a component body with a fastener hole and a fastener. More specifically, a fastener hole 116 traverses from first side 104 to second side 106 of component body 102 to accommodate a fastener such as a bolt. In one particular embodiment, a countersink 128, which is a conical hole, is cut into first side 104. Countersink 128 is coaxial to fastener hole 116 and is configured to receive the head of a bolt or fastener disposed in the fastener hole 116 to minimize the protrusion the head of the bolt/fastener beyond the first side. Likewise, in one embodiment, a counterbore 130 is provided on second side 106 to receive a nut. Counterbore 130 is coaxial to fastener hole 116 and is configured to receive the nut such that the nut's protrusion form the second side 106 is minimized. In one embodiment, the counterbore 130 is shaped to prevent rotation of the locking nut when engaged with a fastener received through fastener hole 116 and to spread force on the locking nut to component body 102. To this end, in one embodiment, counterbore 130 has a polygonal shape such as a hexagon or square. In yet another embodiment of the present invention, counterbore 130 is elliptical shaped. Still other embodiments for preventing the rotation of the nut/bolt or fastener are within the scope of this invention. Additionally, other means may be used to “lock” the nut in place, including, for example, looking nuts, lock washers or commercial-available adhesives for “locking” fasteners in place.

Referring to FIGS. 1(A) and 1(B), another embodiment of the connector is shown comprising interference fit members. More specifically, an interference orifice 124 is provided on first side 104 and is located at a predetermined distance from an edge formed by first side 104 and first end 108. In one embodiment of the present invention, interference orifice 124 has hexagonal cross section. In another embodiment of the present invention, interference orifice 124 has square cross section. Second side 106 includes an interference protrusion 126 located essentially on the opposite side of the interference orifice 124 such that interference protrusion 126 of one conduit distribution component is capable of mating with an interference orifice 124 of a second conduit distribution component and establishing an interference fit. Shapes and sizes of interference protrusion 126 and interference orifice 124 can be varied to allow mating of interference protrusion 126 with interference orifice 124.

Referring to FIGS. 1(A) and 1(B), yet another embodiment of the connector is shown comprising orientation members. More specifically, the first side 104 further includes a projection along the edge formed by first side 104 and second end 110 to form an first orientation feature 132 capable of mating with a second orientation feature 134 located on second side 106 of a second conduit distribution component. Second orientation feature 134 is formed on second side 106 as a recess extending from edge formed by second side 106 and second end 110 to counterbore 130. The width of second orientation feature 134 is equal to about the width of counterbore 130 and first orientation feature 132, and the depth of second orientation feature 134 is equal to about the height of first orientation feature 132.

It should be understood that any combination of the connectors described above may be employed within the scope of the invention.

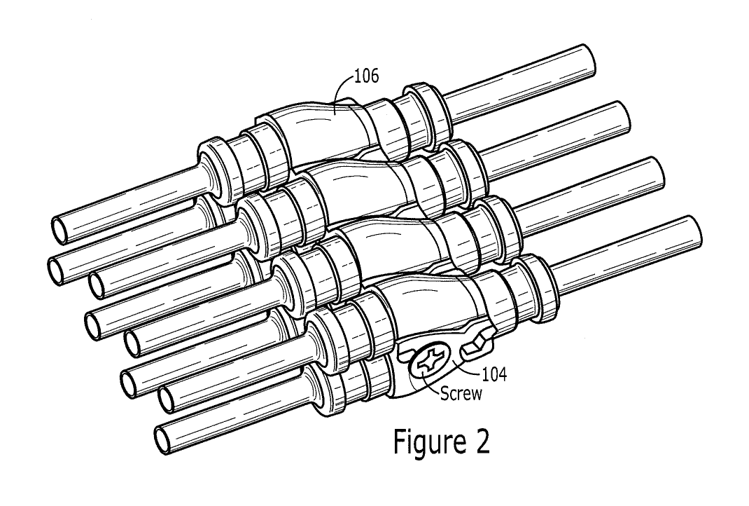

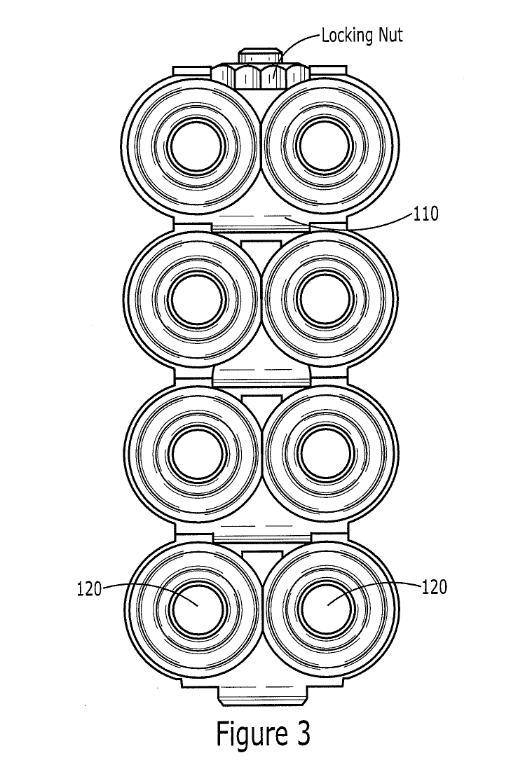

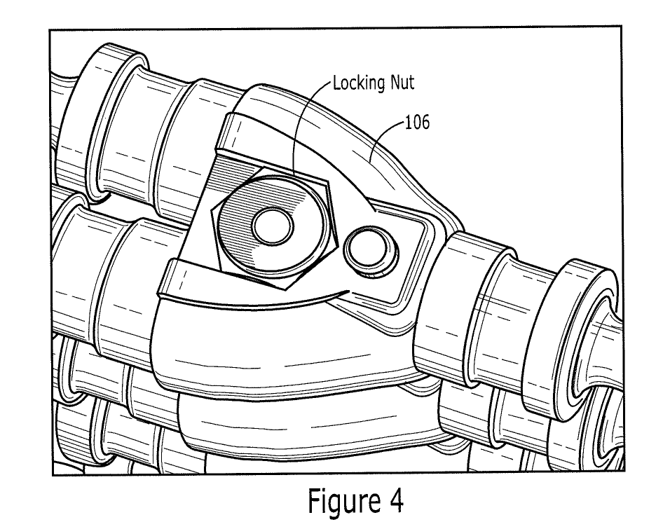

Embodiments in accordance with the present invention allow for multiple optical conduit distribution components to be stacked together into assemblies, as shown in FIG. 2. Each optical conduit distribution component can be stacked over a second optical conduit distribution component. For example, with respect to the connector embodiment of FIG. 1, during stacking, the first side 104 of one conduit distribution component faces second side 106 of a second conduit distribution component such that interference protrusion 126 mates with interference orifice 124, first orientation feature 132 mates with second orientation feature 134 and axes of fastener holes 116 of each conduit distribution component align. Mating of first orientation feature 132 with second orientation feature 134 prevents the stacked components from having an undesirable orientation, and mating of interference protrusion 126 with interference orifice 124 prevents stacked components from disassembling while additional components are stacked. In some embodiments of the present invention, a fastener may be inserted from first side 104 through aligned fastener holes 116 of stacked components until the fastener head sit flush with or below the surface of first side 104 in countersink 128, as shown in FIG. 3. A locking nut may be insert into counterbore 130 to engage with the inserted fastener and tightened until the locking nut sits flush with or below the surface of second side 106 in counterbore 130, as shown in FIGS. 3 and 4. In other embodiments of the present invention, a fastener may be inserted through aligned fastener holes 116 to mount a single conduit distribution component or stacked components to equipment or other rigid surfaces. Multiple optical conduit distribution components stacked together in accordance with embodiments of the present invention can be secured using alternative means such as latches, glue, hook and loop connectors, and the like.

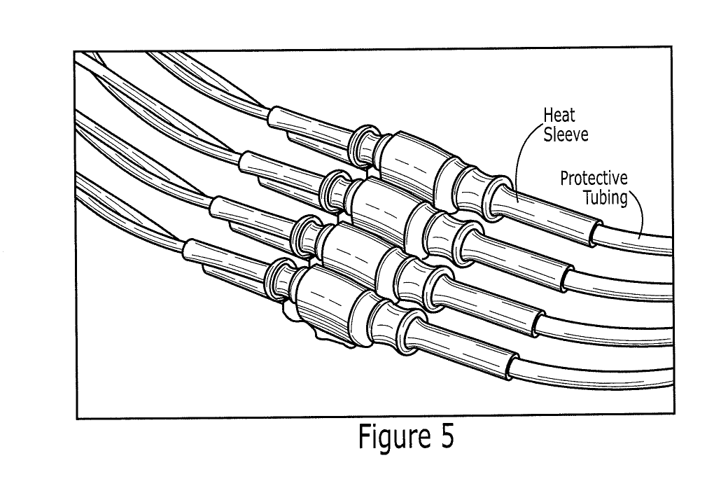

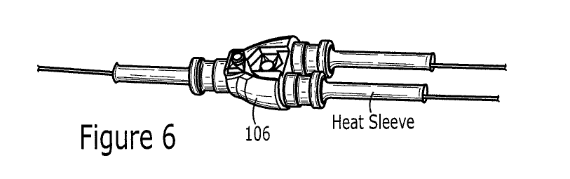

FIG. 5 illustrates an exemplary embodiment in accordance with the present invention in which conduits are distributed through stacked optical conduit component assemblies. In each component, a conduit bundle enters through first conduit opening 118 and the conduits within the bundle are split into two groups of conduits within component body 102, and each group of conduits exit through second conduit openings 120. Conduit bundles entering first conduit openings 118 are pulled through a protective tubing having a diameter sufficient to accommodate the conduit bundle. Each conduit bundle exiting the second conduit openings 120 are pushed through two separate protective tubes having diameters sufficient to accommodate the exiting conduit bundles. Each protective tubing is inserted into the corresponding first conduit opening 118 or second conduit opening 120 and unshrunk heat sleeves are slid over each tubing-first conduit opening and tubing-second conduit opening transitions. In some embodiments of the present invention, protective tubes are affixed with adhesive before unshrunk heat sleeves are slid over each tubing-first conduit opening and tubing-second conduit opening transitions. One end of each heat sleeve is placed over protective tubing and a second end of the heat sleeve is placed over the corresponding first conduit opening or second conduit opening lip 122. Lip 122 of each first conduit opening 118 and second conduit openings 120 will prevent heat sleeves from slipping out. Heat sleeves placed over each tubing-first conduit opening and tubing-second conduit opening transitions are further secured by heat treating to obtain a snug fit, as shown in FIG. 6.

Embodiments of the present invention can further include conventional mounting members for affixing conduit distribution component 100 to a surface in order to prevent vibrations and/or undesirable movements. Mounting members can take the form suitable for mating with mating members on a surface or a housing. Exemplary mounting member can take the form of a rectangular or square, substantially planar mounting member or panel, although the present disclosure is not limited thereto. In exemplary embodiments, mating member is a substantially T-shaped or fin- shaped component or protrusion that extends from a surface or a housing.

Embodiments in accordance with the present invention prevent entangling of optical conduits, prevent excessive bending by providing rigidity to connection and distribution points, and a convenient method for distributing optical conduits within a cable assembly such that the distributed conduits are organized for easy access and protects the conduits from damage. Embodiments in accordance with the present invention provide strain relief to conduits, the result of such assembly is structurally sound and prevents the breaking of conduits. Inventors of the present invention have also discovered that multiple optical conduit distribution component components in accordance with the present invention can be secured to each other during assembly and then treated to provide a robust subassembly.

It is thought that the optical conduit distribution component of the present invention and many of its attendant advantages will be understood from the foregoing description and it will be apparent that various changes may be made in the form, construction arrangement of parts thereof without departing from the spirit and scope of the invention or sacrificing all of its material advantages, the form hereinbefore described being merely a preferred or exemplary embodiment thereof.

What is claimed is:

1. A conduit distribution component comprising:
a body having at least a first and second end and a first and second side;
a first conduit opening at said first end;
a plurality of second conduit openings at said second end;
at least one connector on at least said first side or said second side of said body for connecting said conduit distribution component to a second body of a second conduit distribution component in a side-by-side arrangement.

2. The conduit distribution component of claim 1, wherein said connector comprises:
a fastener hole traversing from said first side to said second side to facilitate the disposition of a fastener therein to connect said conduit distribution component to said second body of said second conduit distribution component.

3. The conduit distribution component of claim 2, wherein said connector further comprises:
an interference protrusion protruding from said first side;
an interference orifice on said second side opposite of said interference protrusion and adapted to receive and hold via an interference fit a second interference protrusion of a second conduit distribution component.

4. The conduit distribution component of claim 3, wherein said connector further comprises:
a first orientation feature on said first side; and
a second orientation feature on said second side adapted to engage a first orientation feature of said second conduit distribution component such that said conduit distribution component and said second conduit distribution component are held in alignment.

5. The conduit distribution component of claim 1, wherein one of said interference orifice or said interference protrusion has a shape and the other has a polygonal shape

6. The conduit distribution component of claim 1, wherein said interference orifice has said polygonal shape.

7. The conduit distribution component of claim 1, wherein said first orientation feature comprises at least one of a protrusion or a recess.

8. The conduit distribution component of claim 2, further comprising:
a countersunk recess located on the first side, wherein the countersunk recess is coaxial to the fastener hole; and
a counterbore recess located on the second side, wherein said counterbore recess is coaxial with the fastener hole, wherein said counterbore recess is shaped to prevent spinning of a nut or bolt head of a fastener disposed in said fastener hole.

9. The conduit distribution component of claim 1, wherein said first and second conduit openings are configured to accommodate optical fiber.

10. The conduit distribution component of claim 1, further comprising a lip located along the outer periphery of the first conduit opening and the outer peripheries of said second conduit openings, said lip being capable of receiving and securing a protective sleeve.

11. The conduit distribution component of claim 10, further comprising an injection molded boot and/or a strain relief over the lip receiving the protective sleeve.

12. The conduit distribution component of claim 10, further comprising said protective sleeve, wherein said protective sleeve is a heat shrink sleeve.

13. The conduit distribution component of claim 1, wherein the component body, the first conduit opening and the second conduit openings form a y-shape.

14. The conduit distribution component of claim 1, said body and said first and second conduit openings are integrally molded.

15. The conduit distribution component of claim 1, wherein said body is rigid.

16. The conduit distribution component of claim 1, said plurality of second conduit openings comprises two second conduit openings.

17. The conduit distribution component of claim 1, further comprising said second conduit distribution component comprising:
said second body having at least a first and second end and a first and second side;
a first conduit opening at said first end;
a plurality of second conduit openings at said second end;
at least one connector on at least said first side or said second side of said second body for cooperating with the said connector of said conduit distribution component to connect said conduit distribution component to said second conduit distribution component in a side-by-side arrangement.

18. A conduit distribution component comprising:
a first conduit distribution component comprising at least:
a first body having at least a first and second end and a first and second side, said first body defining a fastener hole traversing from said first side to said second side;
a first conduit opening at said first end;
a plurality of second conduit openings at said second end;
said second conduit distribution component comprising at least:
said second body having at least a first and second end and a first and second side;
a first conduit opening at said first end;
a plurality of second conduit openings at said second end;
at least connector between said first conduit distribution component and said second conduit distribution component to hold said first conduit distribution component and said second conduit distribution component in a side-by-side arrangement.

19. The conduit distribution component of claim 18, wherein said connector comprises:
a fastener hole traversing from said first side to said second side in each of said first and second bodies to facilitate the disposition of a fastener therein to connect said first conduit distribution component to said second body of said second conduit distribution component.

20. The conduit distribution component of claim 18, wherein said connector comprises:
an interference protrusion protruding from said first side of each of said first and second component bodies; and
an interference orifice on said second side of each of said first and second component bodies, said interference orifice being opposite of said interference protrusion such that said interference orifice of second component receives and holds via an interference fit said interference protrusion of said first conduit distribution component.
